(19) United States
(12) Patent Application Publication
(10) Pub. No.: US 2022/0205487 A1
(43) Pub. Date: Jun. 30, 2022

(54) NOVEL LEMON SHAPED GUIDE TO MINIMIZE EXCESSIVE RUBBING IN ROTATING MACHINES

(71) Applicant: Enaiyat Ghani Ovy, Toronto (CA)

(72) Inventor: Enaiyat Ghani Ovy, Toronto (CA)

(21) Appl. No.: 17/134,328

(22) Filed: Dec. 26, 2020

(51) Int. Cl. F16C 39/02

(52) U.S. Cl. CPC F16C 39/02

(57) ABSTRACT

The present invention highlights a lemon shaped guide that may be used in a rotating machine to suppress excessive rubbing. Rubbing, between a rotor and a guide, is critical in industries; since, it may even lead to severe damages. The lemon shaped guide is based solely on the mechanical design, that is more economical and quickly implementable than the other traditional techniques, such as circular guide, or more advanced sophisticated devices, for example, magnetic bearings. The lemon shaped guide is designed from two circles—having the same radius, and centers on the same line with some distances—which are the most significant designing parameters. Once equipped with a rotating machine, the lemon shaped guide may perform better at minimizing rubbing, between rotor and stator operating at higher speed, than the traditional circular shaped guide.

### BACKGROUND

In industries, rotating machines are widely used, because rotation offers a great way to transfer power from one point to another and convert motion to different planes by gears, belts, shaft, etc. A rotating machine typically includes a rotor, bearings, and a support structure. There are critical relations among these components where each component of a system influences the overall dynamic behavior of a machine. For example, a rotor-to-guide rub degrades a mechanical system over the years and may even cause fatal accidents earlier. It is, therefore, immensely important in industries, to run the rotating machines operating at high speeds smoothly and reliably. The primary reasons of the rubbing between a rotor and a guide are due to a manufacturing error, excessive imbalance, misalignment, bearing wear, smaller radial clearance between the rotating shaft and casing, bad assembly, etc. Rub occurs in rotor casing, seals, unlubricated journal bearings, loose rotor guide attached to restrict a large deflection. The problem is prevalent in the industry and demonstrated in several literatures.

To deal with this problem, the industry has already been using circular shaped guide or bearing to minimize excessive vibration between a rotor and a stator. Although, the circular shaped guide or bearing may reduce the vibration, but the rub, between rotor and guide, may still be present, which may lead to the permanent damage of a mechanical system. The lemon shaped guide is not only effective in minimizing rubbing between the rotor and stator, but also it suppresses the excessive vibration similar to the circular shaped guide.

### BRIEF SUMMARY OF THE INVENTION

A lemon shape guide is designed from two circles, where the intersection of the circles creates a lemon or an elliptical shape. The centers of the circles must be on the same line with a distance, and both circles must have the same radius. The main difference between a circular and lemon shaped guide is that the clearance, between the center of the guide to the surrounding, is always constant, which eventually means the radius of the circle.

On the contrary, the clearance for a lemon shaped guide varies, which distinguishes it from the traditional circular shaped guide. And, this feature of a lemon shaped guide, facilitates the capability to suppress excessive rubbing between a rotor and a stator, operating at high speeds.

### BRIEF DESCRIPTION OF THE DRAWINGS

FIG. 1 shows the procedure to design a lemon shaped guide.

FIG. 2 highlights the detailed technical drawings of the lemon shaped guide.

FIG. 3 illustrates some photographs of the manufactured lemon shaped guide.

FIG. 4 presents implementation of the manufactured lemon shaped guide in a rotor dynamic experiment.

FIG. 5 shows the design of the experimental test rig used to implement the lemon shaped guide.

### DETAILED DESCRIPTION AND BEST MODE OF IMPLEMENTATION

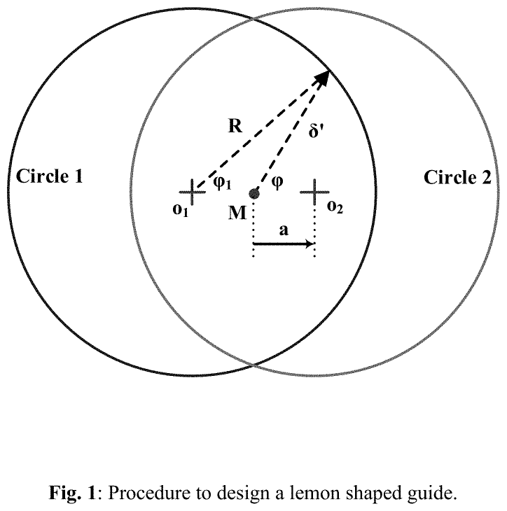

A lemon shaped guide is formed by drawing two circles (circle-1 and circle-2 in FIG. 1). Circle-1 and circle-2 both have the same radius R. Here, o₁ is the center for circle-1, and o₂ is the center for circle-2. Both the centers are on the same line. φ₁ denotes the angle between R and O₁M, and φ is the angle between δ′ and MO₂. M is the center of the lemon type guide. The distance between points M and o₂ and points M and o₁ is represented by α. The equations of circle-1 and -2 are (x+α)²+y²=R² and (x−α)²+y²=R². From FIG. 1, the subtraction of R and α is the ‘nearest gap’ from the center M to the wall of the lemon shaped guide. The lemon shape may be modified by changing the two parameters R and α. So, these two are the most significant parameters for designing a lemon shaped guide.

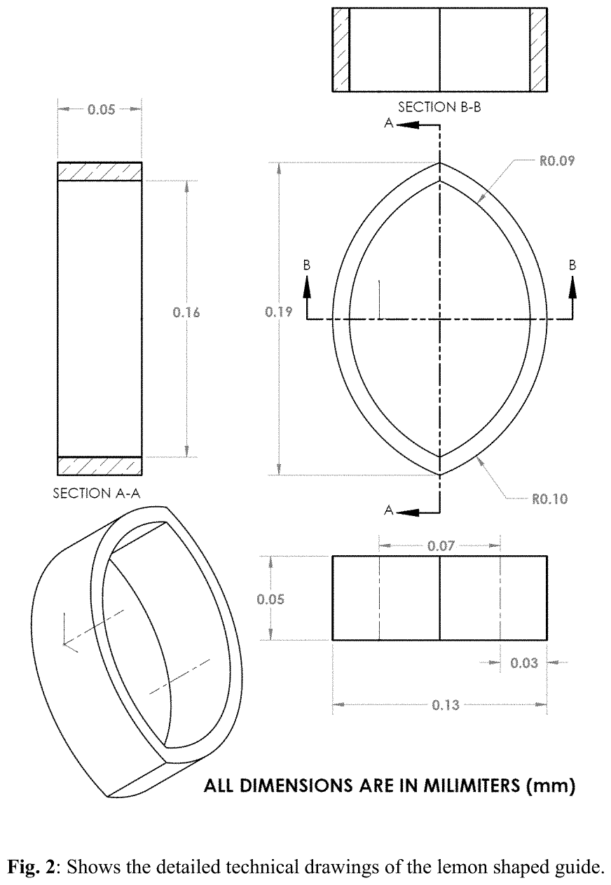

FIG. 2 shows the detailed technical drawings of the lemon shaped guide. Here, all the dimensions are considered depending on the specifications of the particular experimental test rig. This dimensions need to be updated based on the individual experimental setup.

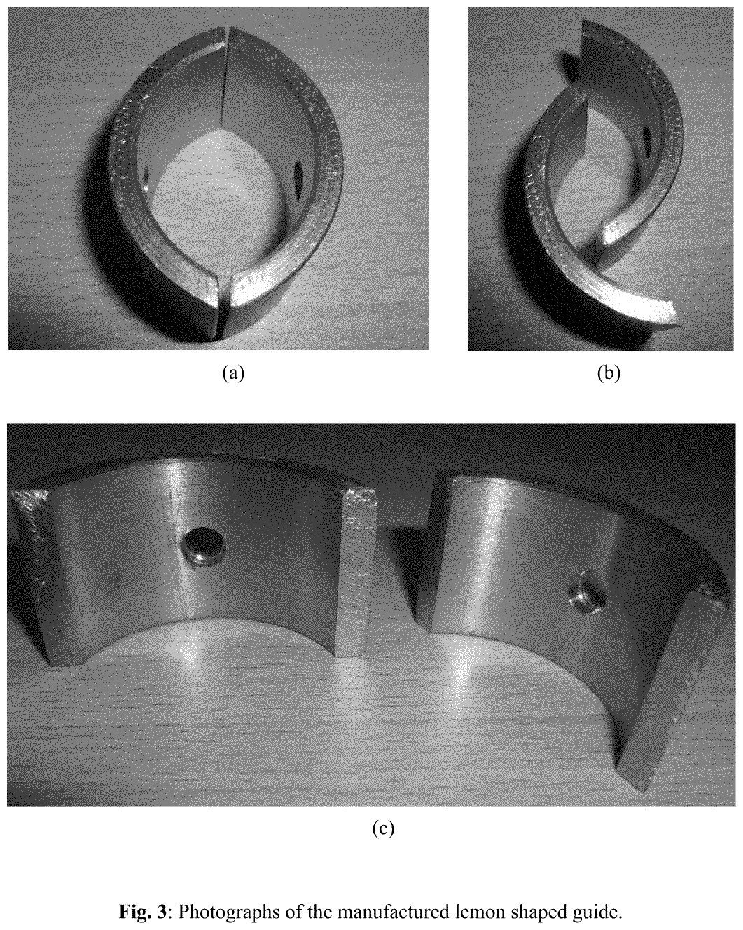

Photographs in FIG. 3 show a physical lemon shaped bearing, which is manufactured from brass material. For this particular shape, the ‘nearest gap’ (subtraction of R and α in FIG. 1) is kept 2 mm, and the ‘longest gap’ (from center M to one of the two edges, top or bottom, in FIG. 1) is 4 mm.

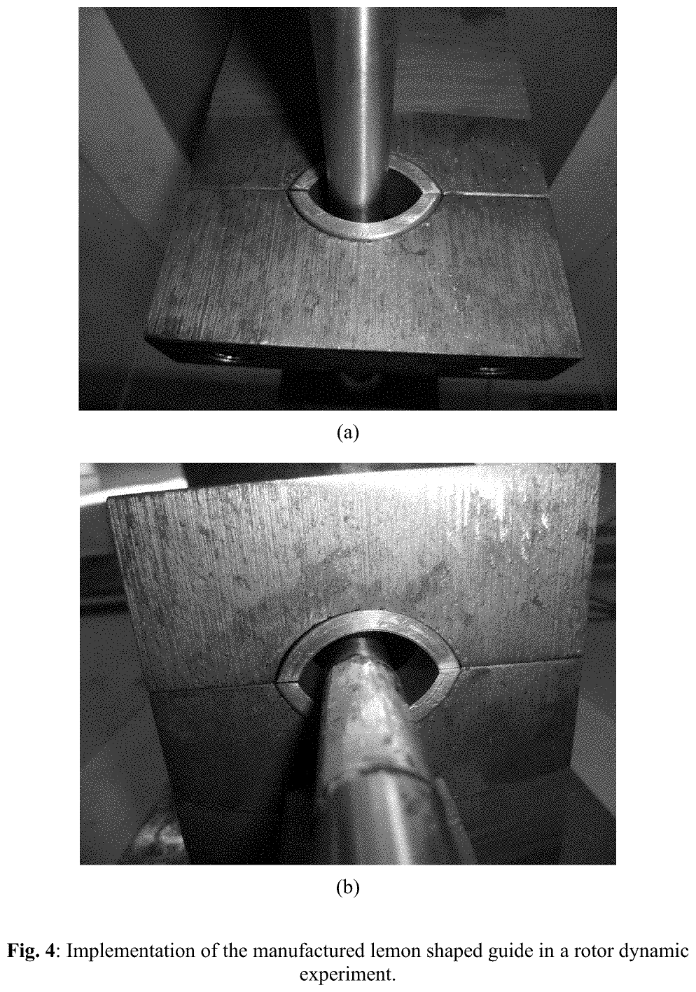

Photographs in FIG. 4 highlight the implementation of a lemon shaped guide in a rotor dynamic experiment. From FIG. 3, we see that the lemon shape is formed by two separate slices where each slice has a hole. This hole is created to install the slice in the support of the experimental test rig, which is seen in FIG. 3. However, this configuration is not mandatory for all setups as individual technique may differ depending on the type of rotating machines.

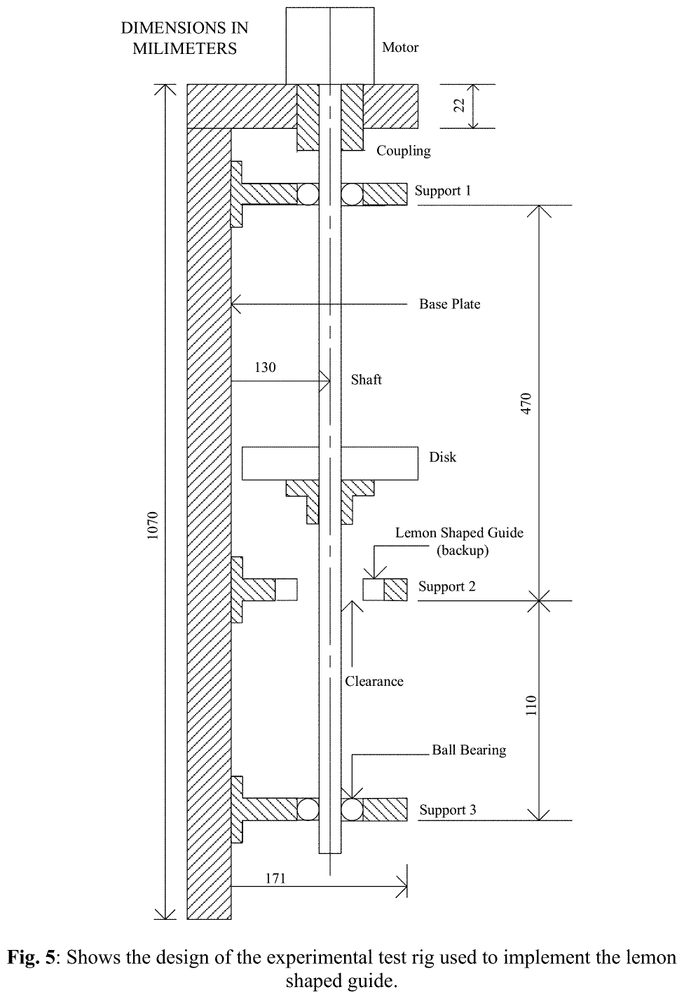

FIG. 5 demonstrates the experimental setup that has been used to evaluate the performance of both circular and lemon shaped guides. This test rig is the simplified form of a rotating machine, which is motivated from the theoretical ‘Jeffcott rotor’ model. An elastic shaft with a radius of 8 mm and a length of 970 mm is supported vertically by the ball bearings at both ends. The inside diameter, outside diameter, and thickness of the upper and lower bearing are 16 mm, 35 mm, and 11 mm, respectively. A disk (rotor) with the radius of 100 mm is attached just at the mid position of the shaft. The disk is supported by a bush, which is then attached to the shaft with the help of a pin. The disk displacements on the plane (x and y directions) are measured by an eddy current sensor. The backup bearing or guide (circular or lemon shaped) is set at the position of 50 mm below the disk with a clearance of 2 mm between the shaft and guide. The overall experimental setup is attached to the wall. It should be noted that to check the performance of a lemon shaped guide, any configurations of rotating machines may be used.

What is claimed is:

1. A Lemon shaped guide performs better in minimizing rubbing between rotor and guide in a rotating machine than the traditional circular shaped guide.

2. The lemon shaped guide may further be modified to a lemon shaped bearing that is similar to a regular angular contact ball or roller bearing configuration.

3. This is a cost-effective solution compared to the advanced magnetic bearing technology since it is a pure mechanical way to suppress excessive rubbing and easy to implement.
